(19) United States
(12) Patent Application Publication
(10) Pub. No.: US 2014/0293340 A1
(43) Pub. Date: Oct. 2, 2014

(54) DISPLAY OPERATION DEVICE, DISPLAY OPERATION METHOD, AND NON-TRANSITORY COMPUTER-READABLE RECORDING MEDIUM CAPABLE OF PREVENTING OPERATION ERROR ON PANEL

(71) Applicant: Kyocera Document Solutions Inc., Osaka (JP)

(72) Inventor: Kazuma Nomura, Osaka (JP)

(73) Assignee: Kyocera Document Solutions Inc., Osaka (JP)

(21) Appl. No.: 14/225,797

(22) Filed: Mar. 26, 2014

(30) Foreign Application Priority Data
Mar. 28, 2013 (JP) 2013-070256

(51) Int. Cl. H04N 1/00

(52) U.S. Cl. CPC H04N 1/00411; H04N 1/00435
USPC 358/1.15

(57) ABSTRACT

A display operation device includes an operation input unit, a temporary display unit, and a confirmation display unit. The operation input unit accepts an input in accordance with an input operation via an operation key and subsequent release of the input operation. The temporary display unit temporarily displays, on a screen, an input result corresponding to the input operation during a period in which the input operation via the operation key is held without being released. The confirmation display unit performs a confirmative display by confirming or resetting the display of the input result when a specified time has elapsed while the input operation is held.

### RELATED APPLICATIONS

This application is based upon, and claims priority to corresponding Japanese Patent Application No. 2013-070256, filed in the Japan Patent Office on Mar. 28, 2013, the entire contents of which are incorporated herein by reference.

### FIELD

Unless otherwise indicated herein, the description in this field section or the background section is not prior art to the claims in this application and is not admitted to be prior art by inclusion in this section. The present disclosure generally relates to a display operation device, operation method, and non-transitory computer-readable recording medium capable of preventing operation errors on a panel.

### BACKGROUND

The present disclosure relates to a display operation device, a display operation method, a non-transitory computer-readable recording medium storing a display operation program, and an image forming apparatus each of which is used to input settings and the like and displays a result of the input.

A typical image forming apparatus, for example, a multifunction peripheral (MFP), includes, as a display operation device, a panel unit having a touch screen. A user inputs operations for various settings, display of input results, etc. via the screen of the panel unit.

Recently, users can perform complicated settings on the panel unit of the MFP. With increasingly complex functions, however, the number of operation keys arranged per screen image displayed on the panel unit increases. This results in a situation that the user often makes an operation error on the panel unit.

### SUMMARY

The present disclosure generally relates to a display operation device, operation method, and non-transitory computer-readable recording medium capable of preventing operation errors on a panel

A display operation device according to an embodiment of the present disclosure includes an operation input unit, a temporary display unit, and a confirmation display unit. The operation input unit accepts an input in accordance with an input operation via an operation key and subsequent release of the input operation. The temporary display unit temporarily displays, on a screen, an input result corresponding to the input operation during a period in which the input operation via the operation key is held without being released. The confirmation display unit performs a confirmative display by confirming or resetting the display of the input result when a specified time has elapsed while the input operation is held.

A display operation method according to an embodiment of the present disclosure includes: accepting an input in accordance with an input operation via an operation key and subsequent release of the input operation; temporarily displaying, on a screen, an input result corresponding to the input operation during a period in which the input operation via the operation key is held without being released; and performing a confirmative display by confirming or resetting the display of the input result when a specified time has elapsed while the input operation is held.

A non-transitory computer-readable recording medium storing a display operation program causes a computer to function as an operation input unit, a temporary display unit, and a confirmation display unit. The operation input unit accepts an input in accordance with an input operation via an operation key and subsequent release of the input operation. The temporary display unit temporarily displays, on a screen, an input result corresponding to the input operation during a period in which the input operation via the operation key is held without being released. The confirmation display unit performs a confirmative display by confirming or resetting the display of the input result when a specified time has elapsed while the input operation is held.

Additional features and advantages are described herein, and will be apparent from the following Detailed Description and the figures.

### BRIEF DESCRIPTION OF THE DRAWINGS

All drawings are intended to illustrate some aspects and examples of the present disclosure. The drawings described are only schematic and are non-limiting, and are not necessarily drawn to scale.

FIG. 1 shows a block diagram illustrating an image forming apparatus including a panel unit according to an embodiment;

FIG. 2 shows a flowchart illustrating a display operation process in an embodiment;

FIGS. 3 shows a schematic diagram illustrating the change of setting screen in accordance with the display operation process in an embodiment;

FIG. 4 shows a block diagram of an image forming apparatus including the panel unit according to another embodiment;

FIGS. 5 shows a schematic diagram illustrating the change of setting screen in an embodiment;

FIGS. 6 shows a schematic diagram illustrating the change of other setting screen in an embodiment;

FIG. 7 shows a block diagram of an image forming apparatus including a panel unit according to a further embodiment;

FIGS. 8 shows a schematic diagram illustrating the change of setting screen in an embodiment;

FIGS. 9 shows a schematic diagram illustrating the change of other setting screen in an embodiment; and

FIG. 10 shows a block diagram of an image forming apparatus including a panel unit according to a still further embodiment.

### DETAILED DESCRIPTION

Various embodiments are described below with reference to the figures. It should be understood, however, that numerous variations from the depicted arrangements and functions are possible while remaining within the scope and spirit of the claims. For instance, one or more elements may be added, removed, combined, distributed, substituted, re-positioned, re-ordered, and/or otherwise changed. Further, where this description refers to one or more functions being implemented on and/or by one or more devices, one or more machines, and/or one or more networks, it should be understood that one or more of such entities could carry out one or more of such functions by themselves or in cooperation, and may do so by application of any suitable combination of hardware, firmware, and/or software. For instance, one or more processors may execute one or more sets of programming instructions as at least part of carrying out one or more of the functions described herein.

Embodiments of the present disclosure will be described below with reference to the drawings.

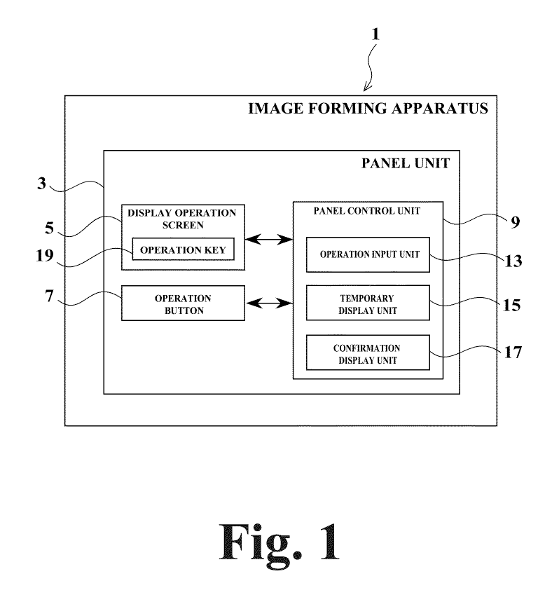

FIG. 1 shows a block diagram illustrating an image forming apparatus 1 including a panel unit according to an embodiment of the present disclosure.

The image forming apparatus 1 according to this embodiment is, for example, a digital multifunction peripheral (MFP). The digital MFP has various functions, such as a print function, a copy function, and a facsimile function. The image forming apparatus 1 according to the embodiment includes a panel unit 3 that serves as a display operation device, in addition to components corresponding to the above-mentioned various functions. In FIG. 1, the components corresponding to the various functions are omitted.

The panel unit 3 includes a display operation screen 5, an operation button 7, a panel control unit 9, and on the like.

The display operation screen 5 is, for example, a liquid crystal display screen of touch panel type. The display operation screen 5 receives input operations for the image forming apparatus 1 and displays the results of the input operations.

The operation button 7 also receives input operations for the image forming apparatus 1 in addition to the display operation screen 5.

The panel control unit 9 includes a processor, a Read Only Memory (ROM) storing operation programs for the processor, and on the like. By executing a display operation program, the panel control unit 9 controls input operations made on the display operation screen 5 and displays the results of the input operations. More specifically, the panel control unit 9 functions as an operation input unit 13, a temporary display unit 15, and a confirmation display unit 17.

The operation input unit 13 realizes an operation input function. The operation input unit 13 accepts an input in accordance with an input operation via an operation key 19 and subsequent release thereof. More specifically, the operation input unit 13 displays the operation key 19 on the display operation screen 5. When the user touches the operation key 19 and then releases it, an input corresponding to that input operation and the subsequent release thereof is accepted by the operation input unit 13. The operation button 7 also functions similarly to the operation key. Thus, an input is accepted when the user presses the operation button 7 and then releases it.

The temporary display unit 15 realizes a temporary display function. The temporary display unit 15 temporarily displays, on the display operation screen 5, the input result corresponding to the input operation while the input operation via the operation key 19 is held without being released.

The confirmation display unit 17 realizes a confirmation display function. When a specified time has elapsed while the input operation is continuously held, the confirmation display unit 17 executes a confirmative display by confirming or resetting the display of the input result.

When the input operation is released before the elapse of a specified time, the confirmation display unit 17 completes the acceptance of the input received by the operation input unit 13 and confirms the display of the input result. When the specified time has elapsed while the input operation is continuously held, the confirmation display unit 17 resets the display of the input result. To measure the specified time, the confirmation display unit 17 counts the time during which the input operation via the operation key 19 is held.

Whether the specified time has elapsed or not may be determined corresponding to the acceptance of the input in accordance with the input operation via the operation input unit 13 and the subsequent release thereof.

When the display of the temporary input result is to be confirmed upon the elapse of the specified time, the confirmation display unit 17 is designed to invalidate the input accepted by the operation input unit 13 if the input operation via the operation input unit 13 is released before the elapse of the specified time.

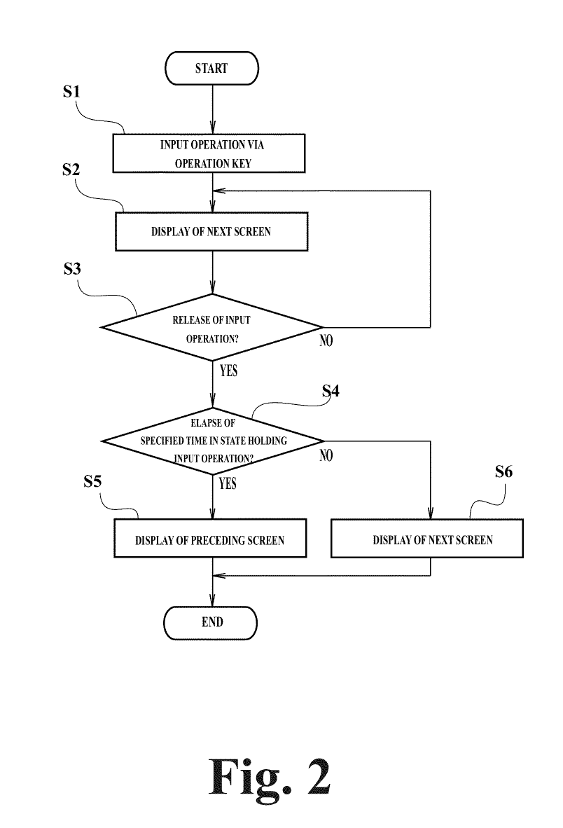

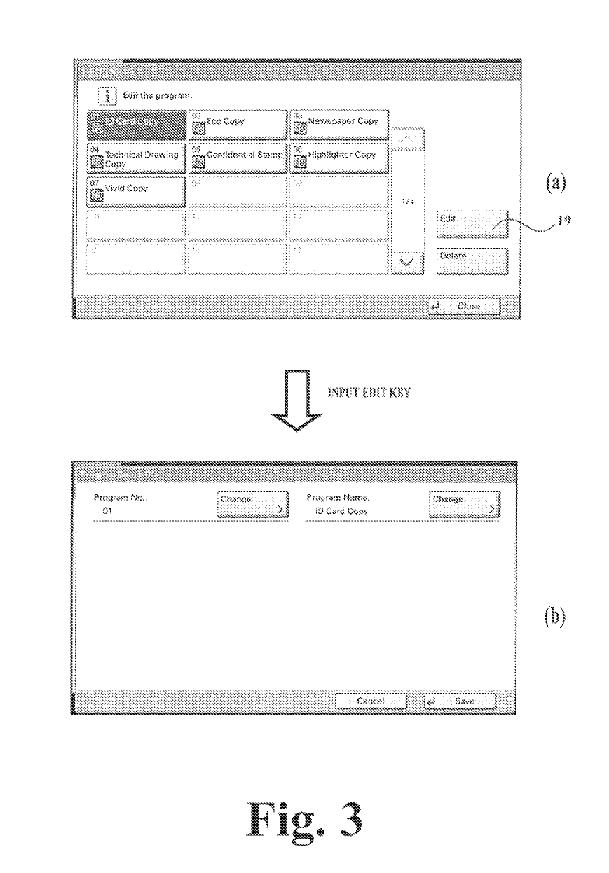

FIG. 2 shows a flowchart illustrating a display operation process. FIG. 3 shows a schematic diagram illustrating the change of setting screen in accordance with the display operation process.

The display operation process in this embodiment will be described below in connection with the change of the setting screen illustrated in FIG. 3 and displayed on the display operation screen 5. When an input via an Edit key (operation key) 19 on the setting screen (a) is received, a next screen (b) is displayed as a result of the input.

In the display operation process, “Input Operation via Operation Key” is first executed in step S1 of FIG. 2. In this step, the operation input unit 13 receives the input operation via the operation key 19 on the display operation screen 5 illustrated in FIG. 3A. The process is then shifted to step S2.

In step S2, “Display of Next Screen” is executed. In this step, the temporary display unit 15 displays the next screen illustrated in FIG. 3B in accordance with the input operation via the operation key 19. The process is then shifted to step S3.

In step S3, determination regarding “Release of Input Operation?” is executed. In this step, the operation input unit 13 determines whether the input operation via the operation key 19 is released or not. If the input operation is released, the input in accordance with the input operation is accepted and the process is shifted to step S4 (as denoted by “YES”).

On the other hand, if the input operation is not released, the process subsequent to step S2 is repeated (as denoted by “NO”). Thus, as long as the input operation via the operation key 19 is continuously held without being released, the display of the next screen by the temporary display unit 15 is maintained. A display time of the next screen in that case, that is, a holding time of the input operation via the operation key 19, is counted by the confirmation display unit 17.

In step S4, determination regarding “Elapse of Specified Time in State Holding Input Operation?” is executed. In this step, corresponding to the acceptance of the input by the operation input unit 13, the confirmation display unit 17 determines whether the specified time has elapsed or not in the state holding the input operation via the operation key 19.

If the specified time has elapsed, the process is shifted to step S5 (as denoted by “YES”). If the specified time has not yet elapsed, the process is shifted to step S6 (as denoted by “NO”).

In step S5, “Display of Preceding Screen” is executed. In this step, the temporary display of the next screen is reset by the confirmation display unit 17 without completing the input received with the input operation. As a result, the preceding screen is confirmatively displayed. Stated in another way, the screen is returned to that displayed before the input operation via the operation key 19.

On the other hand, in step S6, “Display of Next Screen” is executed. In this step, the confirmation display unit 17 completes the input accepted in accordance with the input operation and the subsequent release thereof, and confirms the temporary display of the next screen. As a result, the display of the next screen is confirmatively executed.

In this embodiment, the user can temporarily display the input result and ascertain the input result by holding the input operation via the operation key 19 without releasing the input operation before the input via the operation key 19 is accepted.

Furthermore, in this embodiment, the input result is temporarily displayed without completing the acceptance of the input operation via the input unit before the specified time elapses in the state holding the input operation. Accordingly, the user can avoid from making an operation error.

Moreover, in this embodiment, when the input operation is released before the elapse of a specified time, the confirmation display unit 17 completes the acceptance of the input received by the operation input unit 13 and confirms the temporary display of the input result. When the specified time has elapsed while the input operation is continuously held, the confirmation display unit 17 resets the display of the input result. Therefore, it is also possible for the user skilled in the operation can to display the confirmative input result immediately by performing the input operation and the subsequent release thereof in quick succession. As a consequence, operation error is prevented and convenience for the user is increased. In addition, since there is no need of changing over an erroneous operation preventive mode and an ordinary mode, convenience for the user is further increased.

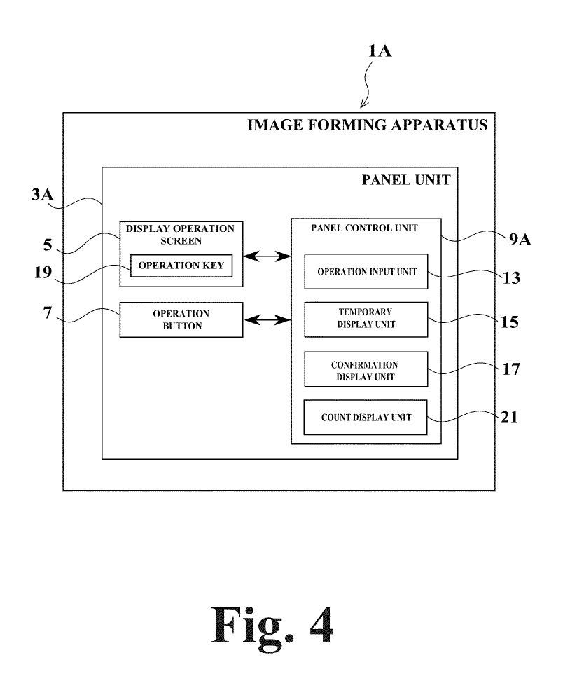

FIG. 4 shows a block diagram illustrating an image forming apparatus 1A including a panel unit according to another embodiment. Note that, because this embodiment has a basic configuration common to the previous embodiment, corresponding components are denoted by reference signs which are the same or suffixed with A, and duplicate description of those components is omitted.

In the image forming apparatus 1A according to this embodiment, a count display unit 21 is added to the configuration of the image forming apparatus 1 according to the first embodiment.

The count display unit 21 realizes a count display function. During a period in which the input operation via the operation key 19 is held, the count display unit 21 displays a count of the elapsed time together with the temporary input result. The count can be displayed by employing a time counted by the confirmation display unit 17. A manner of displaying the count is not limited to particular one. For example, the count display can be provided by adding a countdown number or a progress bar on the next screen (input result) illustrated in FIGS. 3A and 3B.

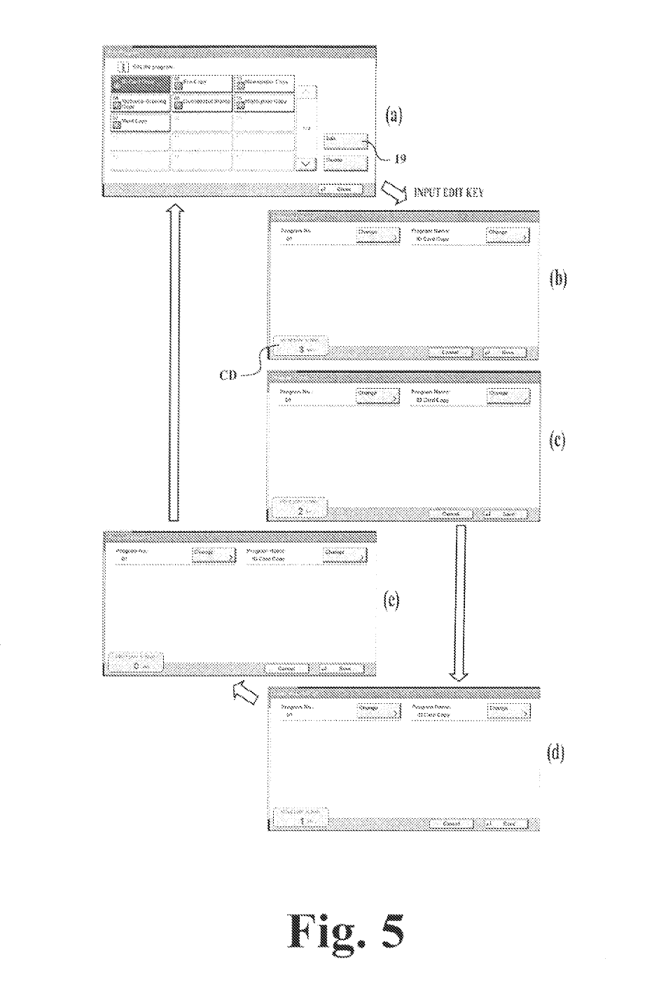

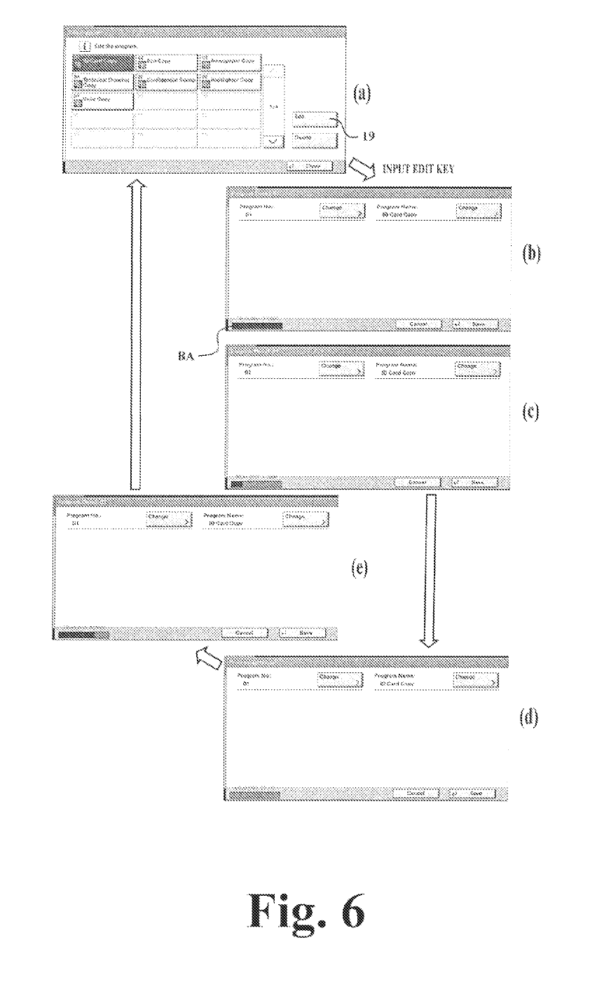

FIGS. 5 and 6 show schematic diagrams illustrating the change of the setting screen in which the count of the elapsed time is added. The setting screens (b)-(e) illustrated in FIG. 5 include countdown display. The setting screens (b)-(e) illustrated in FIG. 6 include a progress bar.

When the input operation is performed via the Edit key (operation key) 19 on the setting screen (a) of FIGS. 5 and 6, countdown display CD or progress bar display BA representing the elapse of the specified time is presented on the next screen as illustrated in FIGS. 5 and 6.

Thus, in this embodiment, since the count display is presented as, for example, the countdown display CD or the progress bar display BA, the user can ascertain the temporal next screen (input result) while recognizing the progress of time until the elapse of the specified time. This embodiment can also provide similar operating advantages to those of the previous embodiment.

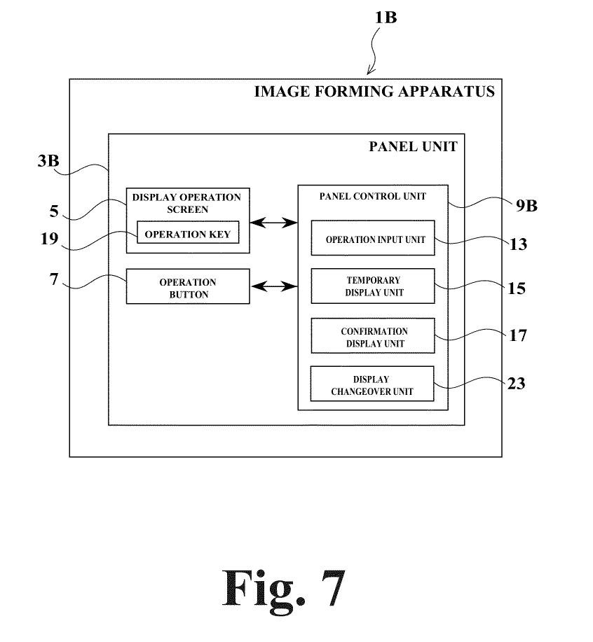

FIG. 7 shows a block diagram illustrating an image forming apparatus 1B including a panel unit according to a further embodiment. Note that, because this embodiment has a basic configuration common to the previous embodiment, corresponding components are denoted by reference signs which are the same or suffixed with B, and duplicate description of those components is omitted.

The image forming apparatus 1B according to this embodiment includes a display changeover unit 23 instead of the count display unit 21 in the second embodiment.

The display changeover unit 23 gradually changes the temporary input result to the display after the reset during a period in which the specified time elapses while the input operation via the operation key 19 is held.

The changeover of the display can be performed depending on the time counted by the confirmation display unit 17. A manner of changing over the display is not limited to particular one. For example, the display can be changed over by gradually fading the next screen (input screen) of FIG. 3B in the previous embodiment, or by gradually transiting the next screen (input screen) to the preceding screen (before the input).

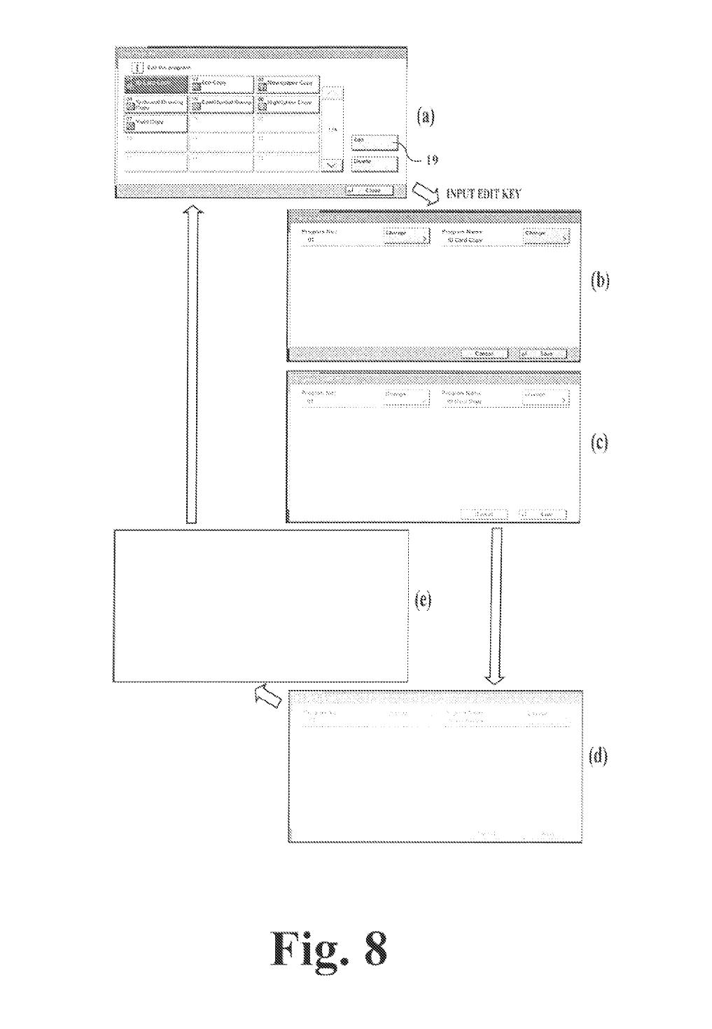

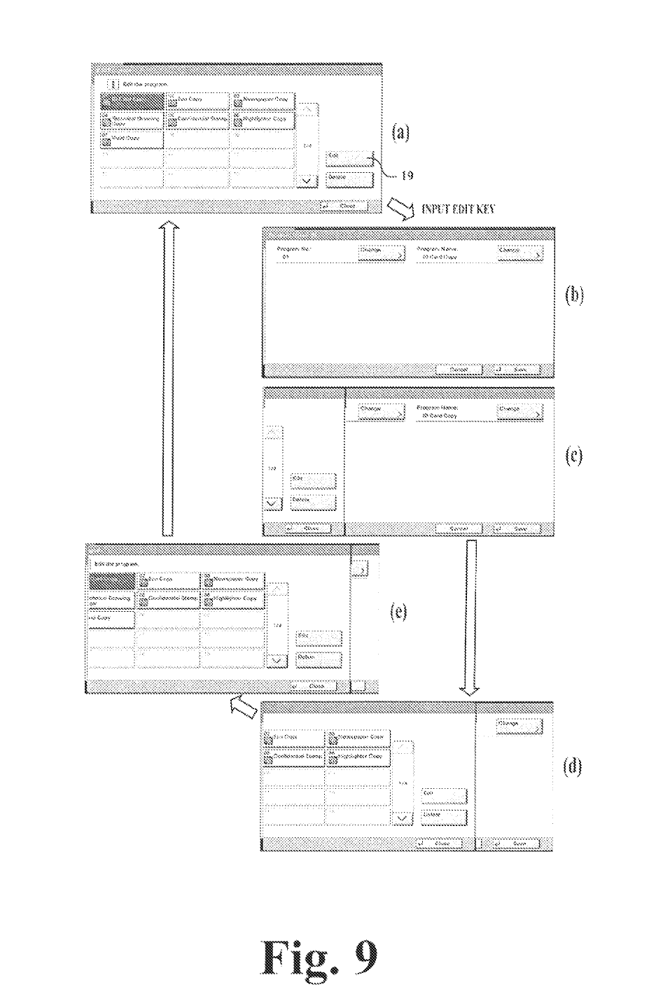

FIGS. 8 and 9 show schematic diagrams illustrating the change of the setting screen in which the next screen displaying the temporary input result is gradually changed over to the display after the reset. As shown in FIG. 8, the next screen is gradually faded. As shown in FIG. 9, the next screen is gradually transited to the preceding screen.

When the input operation is performed via the Edit key (operation key) 19 on a setting screen of FIG. 8A, the temporary next screen is displayed and then gradually faded depending on the elapse of time counted by the confirmation display unit 17 as illustrated in FIGS. 8B to 8E. As an alternative, when the input operation is performed via the Edit key (operation key) 19 on a setting screen of FIG. 9A, the temporary next screen is displayed and thereafter the preceding screen appears gradually from the left end depending on the elapse of time counted by the confirmation display unit 17 as illustrated in FIGS. 9B to 9E.

As a result, this embodiment can also provide similar operating advantages to those in the previous embodiment.

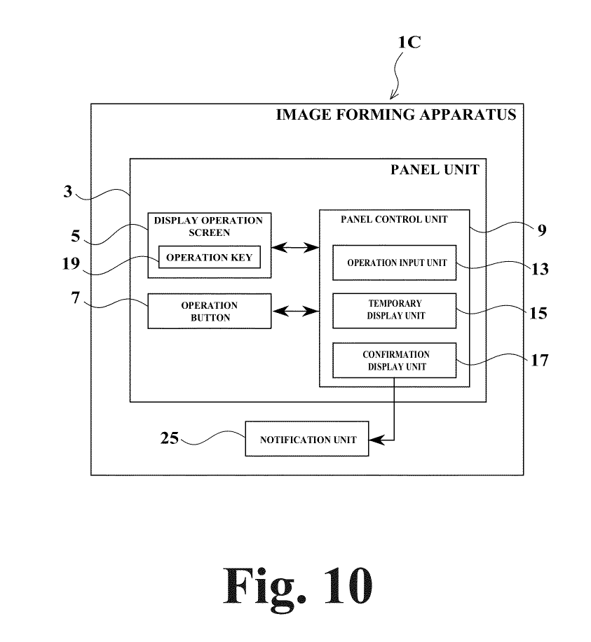

FIG. 10 shows a block diagram illustrating an image forming apparatus 1C including a panel unit according to a still further embodiment. Note that, because this embodiment has a basic configuration common to the previous embodiment, corresponding components are denoted by reference signs which are the same or suffixed with C, and duplicate description of those components is omitted.

In the image forming apparatus 1C according to this embodiment, a notification unit 25 is added to the configuration of the image forming apparatus 1 according to the previous embodiment.

When the specified time has elapsed while the input operation via the operation key 19 is held, the notification unit 25 notifies the user of the elapse of the specified time with sounds or vibration of the operation key 19. The confirmation display unit 17 notifies the elapse of the specified time to the notification unit 25, and the notification unit 25 presents the above-described notification responsively.

The notification with sounds is performed by generating alarm sounds by utilizing, for example, an alarm that is included in the image forming apparatus 1C and that is actuated upon the completion of printing. The notification with vibration is performed by vibrating the display operation screen 5 or the operation button 7 with, for example, a piezoelectric element or a motor.

With this embodiment, the user can recognize the elapse of the specified time without being interfered with viewability of the temporary input result. In addition, this embodiment can also provide similar operating advantages to those in the previous embodiment.

While various aspects and embodiments have been disclosed herein, other aspects and embodiments are possible. Other designs may be used in which the above-described components are each present.

While the embodiments have been described above in connection with the case where the setting screen is changed over to the next screen displaying the input result, the present disclosure can also be applied to the case of displaying the input result without causing changeover to the next screen.

Furthermore, while the embodiments have been described above in connection with the case where the confirmation display unit 17 confirms the display of the input result when the input operation is released before the elapse of the specified time, the present disclosure is not limited to that case. The confirmation display unit 17 may reset the display of the input result when the input operation is released before the elapse of the specified time, and may confirm the display of the input result when the specified time has elapsed while the input operation is held.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

What is claimed is:

1. A display operation device comprising:
an operation input unit configured to accept an input in accordance with an input operation via an operation key and subsequent release of the input operation;
a temporary display unit configured to temporarily display, on a screen, an input result corresponding to the input operation during a period in which the input operation via the operation key is held without being released; and
a confirmation display unit configured to perform a confirmative display by confirming or resetting the display of the input result when a specified time has elapsed while the input operation is held.

2. The display operation device according to claim 1, wherein when the input operation is released before the elapse of the specified time, the confirmation display unit is configured to complete the acceptance of the input received by the operation input unit and confirm the display of the input result, and when the specified time has elapsed while the input operation is held, the confirmation display unit is configured to reset the input result.

3. The display operation device according to claim 2, comprising a display changeover unit configured to gradually change the display of the input result to the display after the reset during a period in which the specified time elapses while the input operation is held.

4. The display operation device according to claim 1, comprising a count display unit configured to display a count of time elapsed while the input operation is held.

5. The display operation device according to claim 2, comprising a count display unit configured to display a count of time elapsed while the input operation is held.

6. The display operation device according to claim 3, comprising a count display unit configured to display a count of time elapsed while the input operation is held.

7. The display operation device according to claim 1, comprising a notification unit configured to notify the elapse of the specified time with sounds or vibration of the operation key.

8. The display operation device according to claim 2, comprising a notification unit configured to notify the elapse of the specified time with sounds or vibration of the operation key.

9. The display operation device according to claim 3, comprising a notification unit configured to notify the elapse of the specified time with sounds or vibration of the operation key.

10. An image forming apparatus comprising a display operation device comprising:
an operation input unit configured to accept an input in accordance with an input operation via an operation key and subsequent release of the input operation;
a temporary display unit configured to temporarily display, on a screen, an input result corresponding to the input operation during a period in which the input operation via the operation key is held without being released; and
a confirmation display unit configured to perform a confirmative display by confirming or resetting the display of the input result when a specified time has elapsed while the input operation is held.

11. A display operation method comprising:
accepting an input in accordance with an input operation via an operation key and subsequent release of the input operation;
temporarily displaying, on a screen, an input result corresponding to the input operation during a period in which the input operation via the operation key is held without being released; and
performing a confirmative display by confirming or resetting the display of the input result when a specified time has elapsed while the input operation is held.

12. The display operation method according to claim 11, comprising:
completing the acceptance of the input received by the operation input unit and confirming the display of the input result when the input operation is released before the elapse of the specified time; and
resetting the input result when the specified time has elapsed while the input operation is held.

13. The display operation method according to claim 12, comprising:
gradually changing the display of the input result to the display after the reset during a period in which the specified time elapses while the input operation is held.

14. A non-transitory computer-readable recording medium storing a display operation program, the display operation program causing a computer to function as:
an operation input unit configured to accept an input in accordance with an input operation via an operation key and subsequent release of the input operation;
a temporary display unit configured to temporarily display, on a screen, an input result corresponding to the input operation during a period in which the input operation via the operation key is held without being released; and
a confirmation display unit configured to perform a confirmative display by confirming or resetting the display of the input result when a specified time has elapsed while the input operation is held.

15. The non-transitory computer-readable storage medium according to claim 14, wherein when the input operation is released before the elapse of the specified time, the confirmation display unit is configured to complete the acceptance of the input received by the operation input unit and confirm the display of the input result, and when the specified time has elapsed while the input operation is held, the confirmation display unit is configured to reset the input result.

16. The non-transitory computer-readable storage medium according to claim 15, the display operation program causing the computer to further function as:
a display changeover unit configured to gradually change the display of the input result to the display after the reset during a period in which the specified time elapses while the input operation is held.
